(19) United States
(12) Patent Application Publication
(10) Pub. No.: US 2011/0267325 A1
(43) Pub. Date: Nov. 3, 2011

(54) LIQUID CRYSTAL DISPLAY PANEL

(75) Inventors: Peng-Bo Xi, Taipei City (TW); Shin-Hung Yeh, Taipei City (TW); Ya-Ling Hsu, Taipei County (TW)

(73) Assignee: AU OPTRONICS CORPORATION, Hsinchu (TW)

(21) Appl. No.: 12/869,760

(22) Filed: Aug. 27, 2010

(30) Foreign Application Priority Data
Apr. 28, 2010 (TW) 99113470

(51) Int. Cl. G09G 3/36; G06F 3/038

(52) U.S. Cl. 345/211; 345/98

(57) ABSTRACT

A liquid crystal display panel includes an active device substrate, an opposite substrate and a liquid crystal layer. The active device substrate includes a plurality of scan lines, a plurality of data lines intersected with the scan lines, and a plurality of pixels. Each pixel at least includes a first, second, and third sub-pixel. The first, second, and third sub-pixels in each pixel are electrically connected with different data lines respectively, while being electrically connected with the same scan line. The opposite substrate having a common electrode is disposed above the active device substrate. Coupling capacitance (Cdc1) between the data line connected with the second sub-pixel and the common electrode is substantially greater than coupling capacitance (Cdc2) between the data line connected with the first sub-pixel and/or third sub-pixel and the common electrode. The liquid crystal layer is disposed between the active device substrate and the opposite substrate.

### CROSS-REFERENCE TO RELATED APPLICATION

This application claims the priority benefit of Taiwan application serial no. 99113470, filed on Apr. 28, 2010. The entirety of the above-mentioned patent application is hereby incorporated by reference herein and made a part of this specification.

### BACKGROUND OF THE INVENTION

1. Field of the Invention

The invention is related to a display panel, and in particular to a liquid crystal display panel.

2. Description of Related Art

With the advancement of display technology, the lives of people have been made more convenient by the assistance of displays. In the pursuit of characteristics such as light weight and thinness, flat panel displays (FDP) have become the mainstream. Among various types of FDPs, liquid crystal displays (LCD) have superb characteristics such as a high space utilization rate, low power consumption, no radiation, and low electromagnetic interference, so that LCDs have become popular among consumers. In recent years, LCD televisions (LCD TV) are developing towards goals of high image definition and large display sizes. In large LCD panels, transmission of signals is easily affected by overall resistive-capacitive (RC) delay of a panel, thereby causing distortion of the signals.

Each of FIGS. 1A and 2A shows a testing pattern of a liquid crystal display. Generally, when inspecting the display quality of an LCD panel, a dot inversion driving method is used and a vertical-strip pattern which shows a display frame of alternating black and white is adopted, so as to monitor the display quality, as shown in FIG. 1A; alternatively, column inversion may be used, and a checkerboard pattern which shows a display frame of alternating black and white blocks is adopted, so as to monitor the display quality, as shown in FIG. 2A. FIGS. 1B and 2B are schematic diagrams showing driving signal waveforms of each sub-pixel, wherein FIGS. 1B and 2B exemplarily represent a pixel P in the upper left corner of FIGS. 1A and 2A.

In each of FIGS. 1A and 2A, the LCD panel includes a plurality of pixel units P arranged in an array, wherein each of the pixel units P includes sub-pixels R, G, and B sequentially arranged along a row. Each of the sub-pixels R, G, and B is electrically connected with a corresponding scan line SL and a data line DL via a corresponding active device. The symbol of “R”, “G”, and “B” respectively represent red, green, and blue sub-pixels, the symbol “+” represents that the voltage of the displayed data which is loaded to the corresponding sub-pixel is greater than a common voltage Vcom, and the symbol “−” represents that the voltage of the displayed data which is loaded to the corresponding sub-pixel is less than the common voltage Vcom. In other words, the symbols “+” and “−” represent opposite polarities. For ease of illustration, in a display panel described in the following, darker regions are used to represent a black frame.

Please refer to both FIGS. 1B and 2B. A signal VDL represents a signal transmitted by the data line DL in FIGS. 1A and 2A, and a signal VGL represents a signal applied to the scan line SL in FIGS. 1A and 2A. When the signal VGL are sequentially applied to the scan lines SL, the data lines DL respectively provide different pixel voltages VR, VG, and VB to be inputted to the corresponding red sub-pixels R, green sub-pixels G, and blue sub-pixels B. However, since the pixel voltages VR and VB are voltages having the same polarity (for example, both have positive polarity), and the pixel voltage VG has a polarity (for example, a negative polarity) opposite to that of the pixel voltages VR and VB, coupling effects between the pixel voltages VR and VB and a common voltage Array_Vcom of the active device substrate cause the common voltage Array_Vcom to drift towards the direction of positive polarity (+), and coupling effects between the pixel electrode VG and the common voltage Array_Vcom cause the common voltage Array_Vcom to drift towards the direction of negative polarity (−). Since the coupling effects between the pixel voltage VG and the common voltage Array_Vcom are not as strong as the coupling effects between the pixel voltage VR and VB and the common voltage Array_Vcom, the level of the common voltage Array_Vcom drifts towards the direction of positive polarity (+). Since a common line of the active device substrate is electrically connected with a common electrode of the opposite substrate, when the level of the common voltage Array_Vcom drifts towards the direction of positive polarity (+), a common voltage CF_Vcom of the opposite substrate is thereby affected and drifts towards the direction of positive polarity (+), wherein the degree of drifting of the common voltage CF_Vcom is less than the degree of drifting of the common voltage Array_Vcom. When the level of the common voltage CF_Vcom drifts towards the direction of positive polarity (+), the voltage difference between the pixel voltages VR and VB and the common voltage CF_Vcom decrease, and the voltage difference between the pixel voltage VG and the common voltage CF_Vcom increases, so that the brightness of the green sub-pixel G is greater than a predetermined brightness, but the brightness of the red sub-pixel R and the brightness of the blue sub-pixel is less than the predetermined brightness, thereby causing the frame displayed by the LCD panel to be greenish and causing incorrect white balance.

In addition to the patterns and driving methods described above and shown in FIGS. 1A and 1B, there are a plurality of additional driving methods. For example, by using a column inversion driving method to display the vertical-strip patterns in FIG. 1A, and by using a dot inversion driving method to display the checkerboard pattern of alternating black and white blocks in FIG. 2A, the same problems of color shifting (greenish issue) or incorrect white balance are also encountered. As LCD panels become larger and larger, and as the size of pixels and the distance between pixels approximate the range of sizes discernable to the human eye, the above phenomenon of color shifting or incorrect white balance are more manifest in large-sized LCD panels. Hence, obvious non-uniformity in brightness is easily generated in LCD panels, thereby affecting the display quality of LCD panels.

Prior art (such as the technical disclosure of U.S. Pat. No. 7,623,190) teaches adjusting the disposition of common lines on the active device substrate, so that the coupling effects between data lines connected with different sub-pixels and common lines on the active device substrate are not the same. However, coupling capacitance (Cdc_Array) between the data lines connected with each sub-pixel and the common lines on the active device substrate vary accordingly, and coupling capacitance (Cdc_CF) between the data lines connected with each sub-pixel and the common electrodes on the opposite substrate also vary accordingly. The prior art does not mention how to alleviate the phenomenon of the shifting of the common voltage CF_Vcom of the opposite substrate, and hence cannot effectively resolve the above phenomenon of color shifting or incorrect white balance. Moreover, in the pixel design disclosed by the prior art, the thicknesses of the liquid crystal layers of each of the sub-pixels at positions above the data lines are the same, and coupling capacitance (Cpd) between the data lines connected with each of the sub-pixels and the pixel electrodes are the same.

### SUMMARY OF THE INVENTION

The invention provides an LCD panel which is capable of improving display uniformity.

The invention provides an LCD panel, which includes an active device substrate, an opposite substrate, and a liquid crystal layer. The active device substrate includes a plurality of scan lines, a plurality of data lines intersected with the scan lines, and a plurality of pixels. Each of the pixels at least includes a first sub-pixel, a second sub-pixel, and a third sub-pixel, wherein the first sub-pixel, the second sub-pixel, and the third sub-pixel of each of the pixels are electrically connected with different data lines respectively and connected with the same scan line. An opposite substrate is disposed above the active device substrate and has a common electrode, wherein coupling capacitance Cdc1 between the data line connected with the second sub-pixel and the common electrode is substantially greater than coupling capacitance Cdc2 between the data line connected with the first sub-pixels and/or with the third sub-pixel and the common electrode. The liquid crystal layer is disposed between the active device substrate and the opposite substrate.

The invention provides another LCD panel, which includes an active device substrate, an opposite substrate, and a liquid crystal layer. The active device substrate includes a plurality of scan lines, a plurality of data lines intersected with the scan lines, and a plurality of pixels. Each of the pixels at least comprises a first sub-pixel, a second sub-pixel, and a third sub-pixel, wherein the polarity of the first sub-pixel is opposite to the polarity of the second sub-pixel, and the polarity of the first sub-pixel is the same as the polarity of the third sub-pixel. The first sub-pixel, the second sub-pixel, and the third sub-pixel of each of the pixels are electrically connected with different data lines respectively and connected with the same scan line. An opposite substrate is disposed above the active device substrate and has a common electrode, wherein coupling capacitance Cdc1 between the data line connected with the second sub-pixel and the common electrode is substantially greater than coupling capacitance Cdc2 between the data line connected with the first sub-pixels and/or with the third sub-pixel and the common electrode. The liquid crystal layer is disposed between the active device substrate and the opposite substrate.

According to an embodiment of the invention, the above first sub-pixels are red sub-pixels, the second sub-pixels are green sub-pixels, and the third sub-pixels are blue sub-pixels.

According to an embodiment of the invention, the active device substrate further includes an additional layer, wherein the additional layer is disposed beneath a part of the data line connected with the second sub-pixel, and a distance d1 between the part of the data line connected with the second sub-pixel and the common electrode is substantially less than a distance d2 between the part of the data line connected with the first sub-pixel and/or with the third sub-pixel and the common electrode.

According to an embodiment of the invention, the material of the additional layer is substantially the same as a material of the scan lines.

According to an embodiment of the invention, the material of the additional layer comprises silicon nitride or polysilicon.

According to an embodiment of the invention, the active device substrate further includes a conductive pattern, wherein the part of the data line connected with the second sub-pixel is electrically connected with the conductive pattern and is disposed beneath the conductive pattern, and a distance d1′ between the conductive pattern and the common electrode is substantially less than a distance d2′ between each of the data lines and the common electrode.

The invention provides another LCD panel, which includes an active device substrate, an opposite substrate, and a liquid crystal layer. The active device substrate includes a plurality of scan lines, a plurality of data lines intersected with the scan lines, and a plurality of pixels. Each of the pixels at least includes a first sub-pixel and a second sub-pixel, wherein the first sub-pixel and the second sub-pixel of each of the pixels are electrically connected with different data lines respectively and connected with the same scan line. The opposite substrate is disposed above the active device substrate and has a common electrode. Coupling effects between the first sub-pixel and the common electrode should be substantially greater than coupling effects between the second sub-pixel and the common electrode. The coupling capacitance Cdc1 between the data line connected with the second sub-pixel and the common electrode is substantially greater than the coupling capacitance Cdc2 between the data line connected with the first sub-pixel and the common electrode. The liquid crystal layer is disposed between the active device substrate and the opposite substrate.

According to an embodiment of the invention, the active device substrate further includes an additional layer, wherein the additional layer is disposed beneath the part of the data line connected with the second sub-pixel, and the distance d1 between the part of the data line connected with the second sub-pixel and the common electrode is substantially less than the distance d2 between the part of the data line connected with the first sub-pixel and the common electrode.

According to an embodiment of the invention, the material of the additional layer is substantially the same as a material of the scan lines.

According to an embodiment of the invention, the material of the additional layer comprises silicon nitride or polysilicon.

According to an embodiment of the invention, the active device substrate further includes a conductive pattern, wherein the part of the data line connected with the second sub-pixel is electrically connected with the conductive pattern and is disposed beneath the conductive pattern, and a distance d1′ between the conductive pattern and the common electrode is substantially less than a distance d2′ between each of the data lines and the common electrode.

According to the above, in the embodiments of the invention, by making the coupling capacitance Cdc1 between the data line connected with the second sub-pixel and the common electrode of the opposite substrate substantially greater than the coupling capacitance Cdc2 between the data line connected with the first sub-pixel and/or with the third sub-pixel and the common electrode of the opposite substrate, the drifting of a common voltage CF_Vcom of the opposite substrate is compensated for, thereby being beneficial to improving the brightness uniformity of each of the sub-pixels, so that color shifting is avoided.

In order to make the aforementioned and other objects, features and advantages of the invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 2A each shows a testing pattern of an LCD.

FIGS. 1B and 2B are schematic diagrams showing driving signal waveforms of sub-pixels of each color in FIGS. 1A and 2A, respectively.

FIG. 3 is a partial schematic top view of an active device substrate according to the first embodiment of the invention.

FIG. 4 is a schematic cross-sectional view along a line I-I′ of FIG. 3.

FIG. 5A is a schematic diagram of an equivalent circuit of a sub-pixel within an active device substrate according to an embodiment of the invention.

FIG. 5B is a schematic diagram showing driving signal waveforms of each sub-pixel within a pixel.

FIGS. 6 and 7 are partial schematic cross-sectional views of active device substrates according to the second and third embodiments of the invention, respectively.

FIG. 8 is a partial schematic cross-sectional view of an active device substrate according to the fourth embodiment of the invention.

FIGS. 9 and 10 are partial schematic cross-sectional views of active device substrates according to the fifth and sixth embodiments of the invention, respectively.

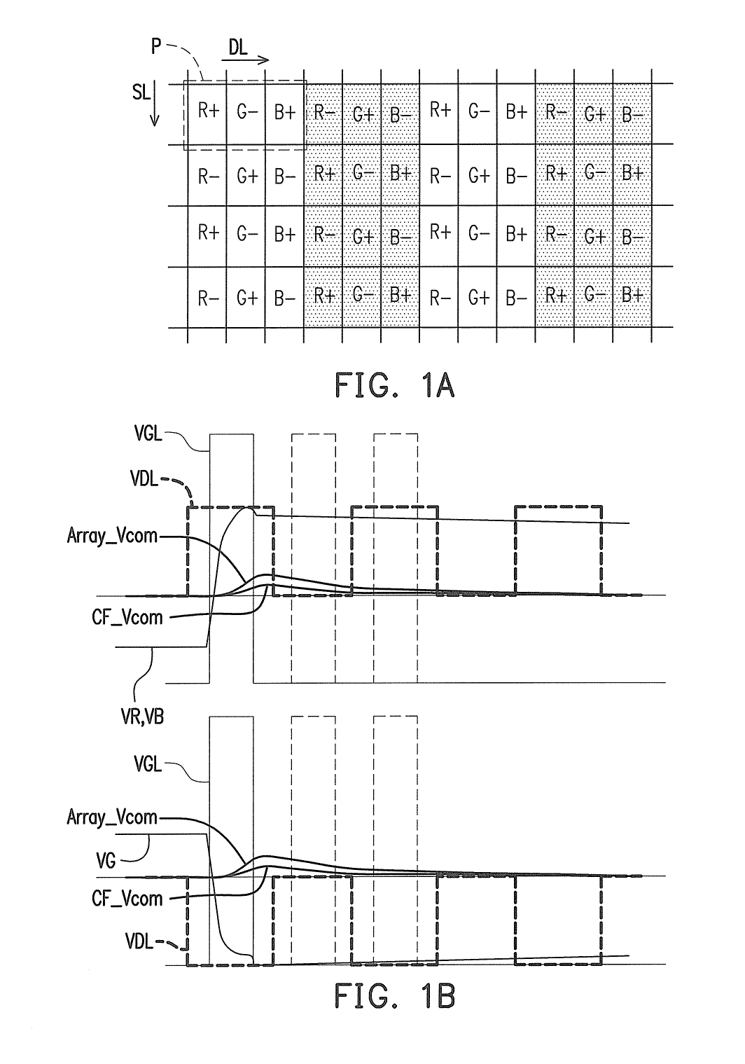

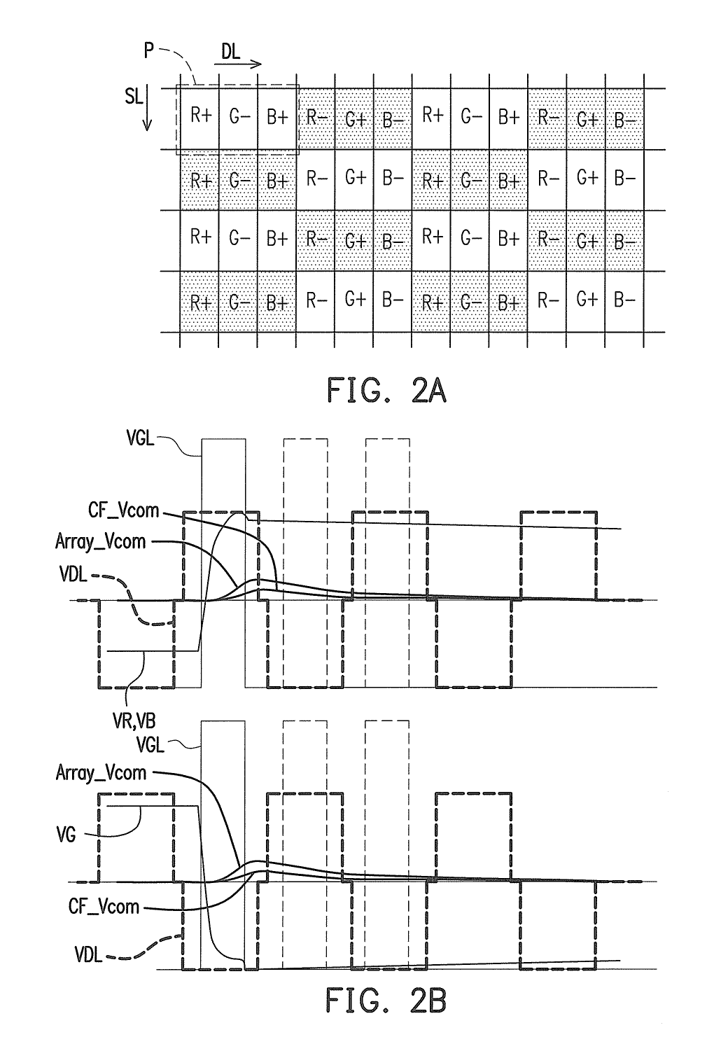

### DESCRIPTION OF THE EMBODIMENTS

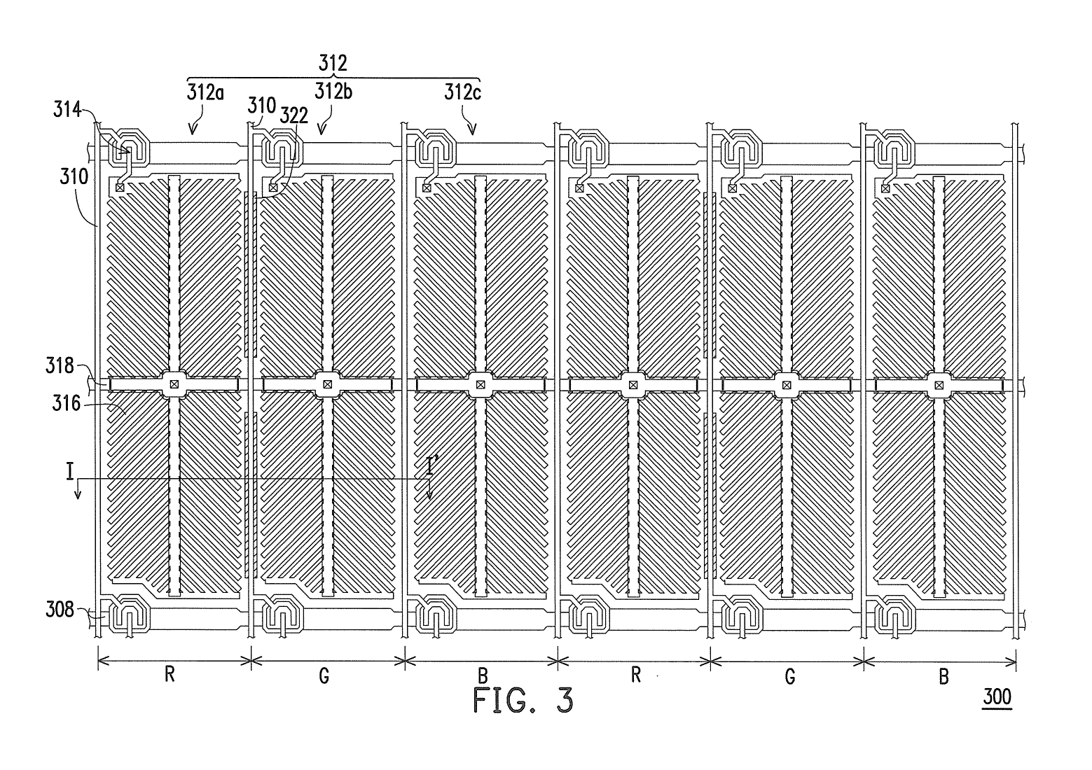

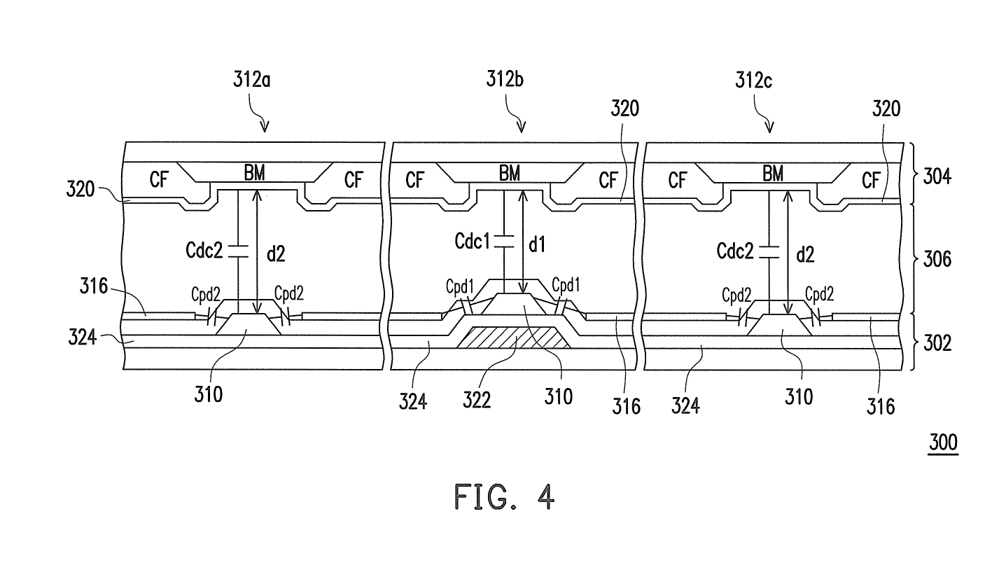

Next, the embodiments of the invention are further described by using top views and cross-sectional views. FIG. 3 is a partial schematic top view of an active device substrate according to the first embodiment of the invention. FIG. 4 is a schematic cross-sectional view along a line I-I′ of FIG. 3. In FIG. 3, an opposite substrate and a liquid crystal layer are omitted for ease of description. Said omission, however, is not intended to limit the scope of the invention.

Please refer to FIGS. 3 and 4. An LCD panel 300 includes an active device substrate 302, an opposite substrate 304, and a liquid crystal layer 306. The opposite substrate 304 is disposed above the active device substrate 302. The liquid crystal layer 306 is disposed between the active device substrate 302 and the opposite substrate 304.

The active device substrate 302 includes a plurality of scan lines 308, a plurality of data lines intersected with the scan lines 308, and a plurality of pixels 312. Each of the pixels 312 at least includes a first sub-pixel 312a, a second sub-pixel 312b, and a third sub-pixel 312c. The first sub-pixel 312a, the second sub-pixel 312b, and the third sub-pixel 312c are each electrically connected with the corresponding scan line 308 and data line 310 which are used to transmit signals to each of the sub-pixels. The first sub-pixel 312a, the second sub-pixel 312b, and the third sub-pixel 312c in each of the pixels 312 are electrically connected with different data lines 310 and are electrically connected with the same scan line 308.

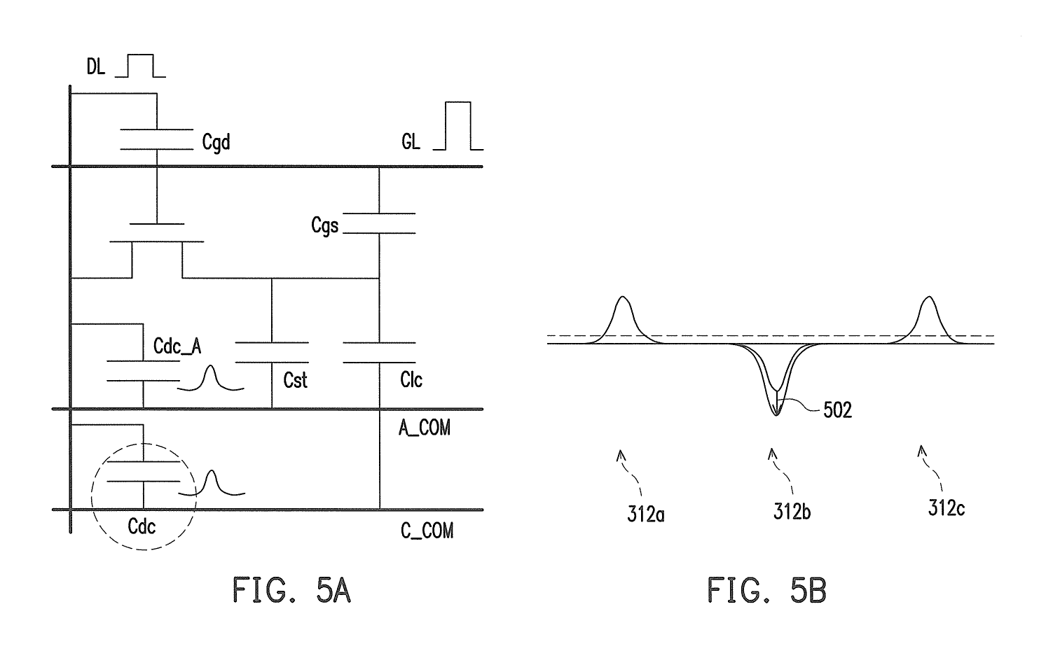

In detail, the scan lines 308 respectively intersected with the data lines 310 and demarcate a plurality of sub-pixel regions on the active device substrate 302. A portion of the active device substrate 302 within each of the sub-pixel regions further includes an active device 314, a pixel electrode 316, and a common line 318. The active device 314 is coupled to the corresponding scan line 308 and data line 310, and the first sub-pixel 312a, the second sub-pixel 312b, and the third sub-pixel 312c are each coupled to the corresponding active device 314. The common line 318 is disposed beneath the pixel electrode 316, and forms a storage capacitor Cst (shown in FIG. 5A) with the pixel electrode 316, so as to maintain the display quality of the pixel electrode 316.

The opposite substrate 304 includes a common electrode 320. In detail, the opposite substrate 304 is, for example, a color filter substrate which includes a plurality of color filters CF and a plurality of black matrixes BM, wherein the black matrixes BM are disposed between the color filters CF, for example, the two adjacent color filters CF. The common electrode 320 is, for example, disposed between the color filters CF, the black matrixes BM, and the liquid crystal layer 306. In other words, the common electrode 320 is, for example, disposed on the color filters CF and the black matrixes BM. Hence, arrangements of liquid crystal molecules in the liquid crystal layer 306 are controlled by electrical fields between the common electrode 320 and the pixel electrode 316 of the active device substrate 302.

According to the present embodiment, by changing the arrangement of different colors of the color filters CF in the opposite substrate 304, the pixel 312 is made to include a plurality of strips of the first sub-pixels 312a displaying a first color, a plurality of strips of the second sub-pixels 312b displaying a second color, and a plurality of strips of the third sub-pixels 312c displaying a third color. The first sub-pixel 312a, the second sub-pixel 312b, and the third sub-pixel 312c in each row are, for example, arranged in a sequential and alternating manner. According to an embodiment, the second sub-pixel 312b is located between the first sub-pixel 312a and the third sub-pixel 312c. In practice, in order to achieve effects of full color, sub-pixels of the three primary colors are often chosen. In detail, the above first sub-pixel 312a is a red sub-pixel (R), the second sub-pixel 312b is a green sub-pixel (G), and the third sub-pixel 312c is a blue sub-pixel. However, the invention is not limited to this configuration and the colors. Of course, in other embodiments, the second sub-pixel 312b may be not between the first sub-pixel 312a and the third sub-pixel 312c, but on any side of the first sub-pixel 312a or any side of the third sub-pixel 312c.

In detail, when a column inversion driving method is used to drive the LCD panel 300, a first polarity signal is input to the odd-numbered data lines 310, and a second polarity signal is input to the even-numbered data lines 310. Hence, when a driving signal is applied to the scan lines 308 sequentially from top to bottom, each of the data lines 310 provides a different data voltage to be input to the corresponding sub-pixel. For ease of description, the symbols “+” and “−” are used to represent the polarities of the voltage levels. As in the embodiment shown in FIG. 3, the first sub-pixel 312a, the second sub-pixel 312b, and the third sub-pixel 312c of the same row respectively have positive polarity (+), negative polarity (−), and positive polarity (+), and the first sub-pixel 312a, the second sub-pixel 312b, and the third sub-pixel 312c of the next row adjacent to the above third sub-pixel 312c of positive polarity (+)respectively have negative polarity (−), positive polarity (+), and negative polarity (−).

Of course, according to another embodiment, a dot inversion driving method may be used to drive the LCD panel 300. Specifically, the first sub-pixels 312a of the same row sequentially have positive polarity (+), negative polarity (−), positive polarity (+), negative polarity (−), and so on, and the second sub-pixels 312b of the next row sequentially have negative polarity (−), positive polarity (+), negative polarity (−), positive polarity (+), and so on, and the third sub-pixels 312c of the row after the next row sequentially have positive polarity (+), negative polarity (−), positive polarity (+), negative polarity (−), and so on. In other words, the first sub-pixel 312a has a different polarity as that of the second sub-pixel 312b adjacent thereto, and the first sub-pixel 312a has the same polarity as that of the third sub-pixel 312c, the invention does not further limit the configuration of the polarities of the sub-pixels.

It should be noted that the active device substrate 302 further includes an additional layer (or namely, pad layer, material layer) 322, which is disposed below a part of the data line 310 which is connected with the second sub-pixel 312b. The pad layer 322 is, for example, disposed beneath a gate insulating layer 324, so that the part of the data line 310 that is connected with the second sub-pixel 312b is electrically insulated from the pad layer 322. In other words, the pad layer 322 elevates the part of the data line 310 that is connected with the second sub-pixel 312b, so that a distance d1 between the part of the data line 310 that is connected with the second sub-pixel 312b and the common electrode 320 is substantially less than a distance d2 between the data line 310 that is connected with the first sub-pixel 312a and/or with the third sub-pixel 312c and the common electrode 320. In other words, the thickness of the liquid crystal layer 306 above the data line 310 that is connected with the second sub-pixel 312b is substantially less than the thickness of the liquid crystal layer 306 above the data line that is connected with the first sub-pixel 312a and/or with the third sub-pixel 312c. According to an embodiment, the material of the pad layer 322 may be substantially the same as the material of the scan line 308, i.e. the pad layer 322 and the scan line 308 are, for example, formed by patterning a same metal layer. According to another embodiment, the material of the pad layer 322 may be different from the material of the scan line 308. The material of the pad layer 322 is, for example, an organic dielectric material (such as photo-resist, polymer, or other suitable material), an inorganic dielectric material (such as nitride, oxide, oxynitride, or other suitable material), a semiconductor material (such as poly silicon, amorphous silicon, micro-crystallize silicon, single-crystallize silicon, oxide-semiconductor material, organic semiconductor material, or other suitable material), another suitable material, or a stack of any two of the above materials.

Coupling capacitance Cdc1 exists between the data line 310 connected with the second sub-pixel 312b and the common electrode 314, and coupling capacitance Cdc2 exists between the data line 310 which is connected with the first sub-pixel 312a and/or with the third sub-pixel 312c and the common electrode 314. In other words, the coupling capacitance Cdc2 exists at least one of between the data line 310 which is connected with the first sub-pixel 312a and the common electrode 314 and between the data line 310 which is connected with the third sub-pixel 312c and the common electrode 314. Since the pad layer 322 elevates the part of the data line 310 that is connected with the second sub-pixel 312b, that is, decreasing the distance d1 between the part of the data line 310 that is connected with the second sub-pixel 312b and the common electrode 314, the coupling capacitance Cdc1 between the data line 310 connected with the second sub-pixel 312b and the common electrode 314 is increased, so that the coupling capacitance Cdc1 is substantially greater than the coupling capacitance Cdc2.

In detail, FIG. 5A is a schematic diagram of an equivalent circuit of a sub-pixel within an active device substrate according to an embodiment of the invention. FIG. 5B is a schematic diagram showing driving signal waveforms of each sub-pixel within a pixel. As shown in FIG. 5A, in each of the sub-pixels, coupling capacitance Cdc_{—} A is generated between a data line DL connected with the sub-pixel and a common line A_COM of the active device substrate, and coupling capacitance Cdc is generated between the data line DL connected with the sub-pixel and the common electrode C_COM of the opposite substrate. According to the present embodiment, by adjusting the coupling capacitance Cdc, the voltage differences between each of the sub-pixels and a common voltage CF_Vcom of the opposite substrate are substantially the same.

The following is described according to an example in which the first sub-pixel 312a has positive polarity (+), the second sub-pixel 312b has negative polarity (−), and the third sub-pixel 312c has positive polarity (+). Coupling effects generated between the data line 310 connected with the first sub-pixel 312a or with the third sub-pixel 312c which have positive polarity (+) and the common line 318 of the active device substrate cause a common voltage Array_Vcom transmitted by the common line 318 of the active device substrate to drift towards the direction of positive polarity (+). Coupling effects generated between the data line 310 connected with the second sub-pixel 312b which has negative polarity (−) and the common line 318 cause the common voltage Array Vcom transmitted by the common line 318 of the active device substrate to drift towards the direction of negative polarity (−). Since the coupling effects between the data line 310 connected with the second sub-pixel 312b and the common line 318 of the active device substrate are not as strong as the coupling effects between the data line 310 connected with the first sub-pixel 312a and/or with the third sub-pixel 312c and the common line 318 of the active device substrate, the levels of the common voltage Array_Vcom transmitted by the common line 318 of the active device substrate and of the common voltage CF_Vcom transmitted by the common electrode 314 of the opposite substrate drift towards the direction of positive polarity (+), as shown in FIG. 5B.

According to the present embodiment, the coupling capacitance Cdc1 between the data line 310 connected with the second sub-pixel 312b and the common electrode 314 of the opposite substrate is substantially greater than the coupling capacitance Cdc2 between the data line 310 which is connected with the first sub-pixel 312a and/or with the third sub-pixel 312c and the common electrode 314 of the opposite substrate, so that the situation of the drifting of the common voltage CF_Vcom of the opposite substrate is improved, as shown by the reference numeral 502 in FIG. 5B. Hence, the first sub-pixel 312a, the second sub-pixel 312b, and the third sub-pixel 312c are each able to display a predetermined brightness, thereby being beneficial to improving display uniformity, so as to obtain better display quality.

The pattern and area of the pad layer 322 are not limited to the illustrations in FIG. 3 and may be modified according to actual requirements, as long as the coupling capacitance Cdc1 between the data line 310 connected with the second sub-pixel 312b and the common electrode 314 is increased.

In addition, by disposing the pad layer 322 beneath the part of the data line 310, the distance between the part of the data line 310 and the pixel electrode 316 of the second sub-pixel 312b may be changed, thereby affecting coupling capacitance Cpd1 between the data line 310 connected with the second sub-pixel 312b and the pixel electrode 316. Hence, according to the present embodiment, the disposition of the pixel electrode 316 may be further altered to fine tune the distance between the data line 310 connected with the second sub-pixel 312b and the pixel electrode 316, so that the coupling capacitance Cpd1 between the data line 310 connected with the second sub-pixel 312b and the pixel electrode 316 is substantially equal to coupling capacitance Cpd2 between the data line 310 connected with the first sub-pixel 312a and/or with the third sub-pixel 312c and the pixel electrode 316.

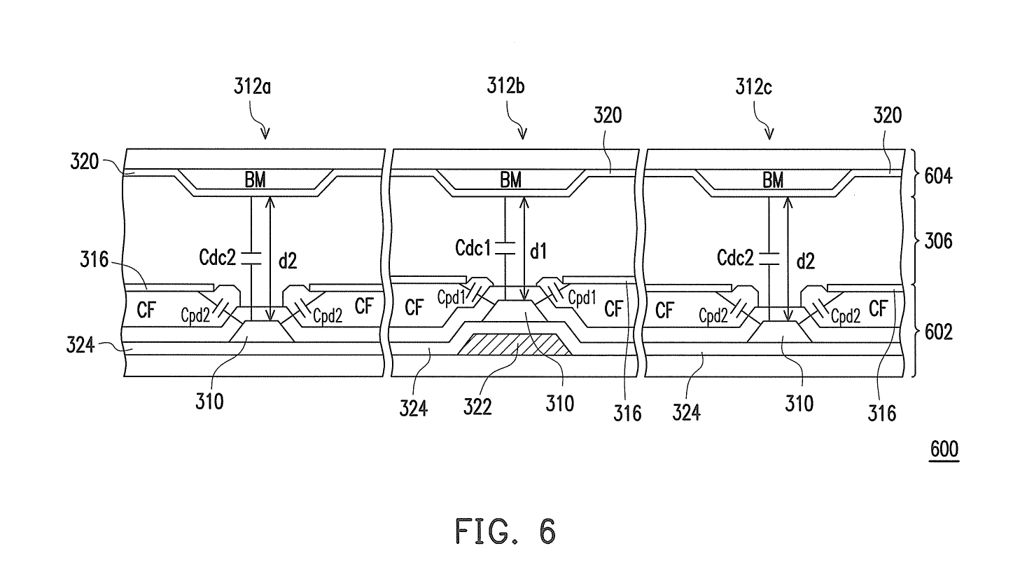

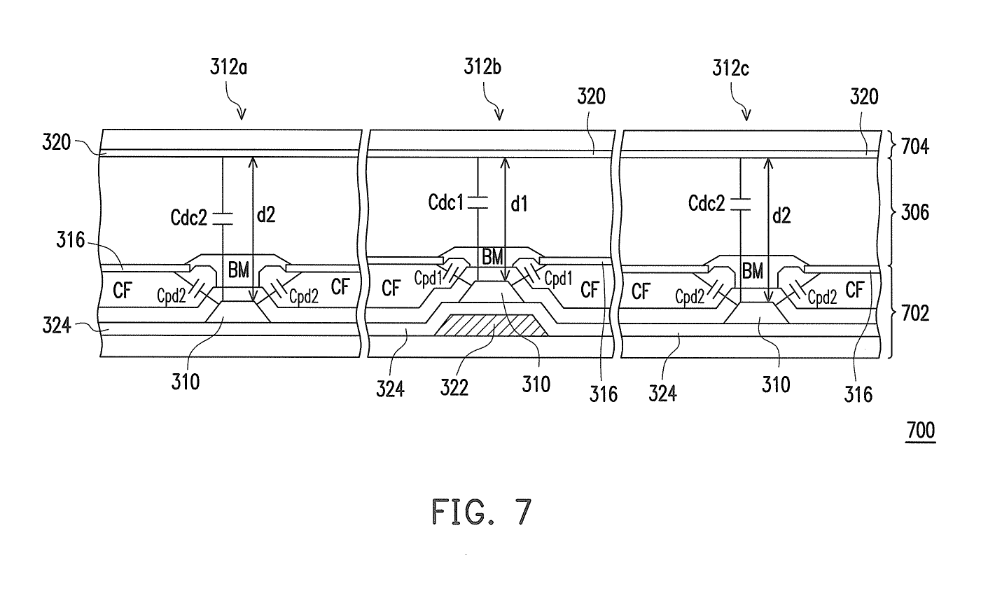

FIGS. 6 and 7 are partial schematic cross-sectional views of active device substrates according to the second and third embodiments of the invention, respectively. It should be noted that in FIGS. 6 and 7, the same elements as those in FIG. 4 are marked by the same reference numerals, and relevant descriptions are omitted.

The elements which form LCD panels 600 and 700 shown in FIGS. 6 and 7 are substantially the same as the elements which form the LCD panel 300 shown in FIG. 4. The main difference in between lies in the disposition of the elements of the active device substrate and the opposite substrate.

Please refer to FIG. 6. In the LCD panel 600 according to the second embodiment, an active device substrate 602 may be a color filter on array (COA) substrate in which the color filters CF are directed integrated on an active layer. The pixel electrodes 316 are disposed on the color filters CF. In addition, an opposite substrate 604 includes the common electrode 320 and the black matrixes BM, whereas the color filters CF are omitted. According to the present embodiment, in the LCD panel 600, a COA substrate which is used as the active device substrate 602 is installed with the opposite substrate 604 which does not include the color filters CF, and the liquid crystal layer 306 is filled in between the two substrates, so that there is lower possibility of misalignment and the pixels have higher aperture ratios.

Please refer to FIG. 7. In the LCD panel 700 according to the third embodiment, an active device substrate 702 may be a black matrix on array (BOA) substrate in which the color filters CF and the black matrixes BM are directed integrated on the active layer. The pixel electrodes 316 are disposed on the color filters CF. In addition, the opposite substrate 604 includes the common electrode 320, whereas the color filters CF and the black matrixes BM are omitted. According to the present embodiment, in the LCD panel 700, the BOA substrate which is used as the active device substrate 702 is installed with the opposite substrate 704 which does not include the color filters CF or the black matrixes BM, and the liquid crystal layer 306 is filled in between the two substrates, so that there is lower possibility of misalignment and the pixels have higher aperture ratios.

Hence, according to the embodiments shown in FIGS. 6 and 7, the disposition of the pixel electrode 316 may be further altered, so that the coupling capacitance Cpd1 between the data line 310 connected with the second sub-pixel 312b and the pixel electrode 316 is substantially equal to the coupling capacitance Cpd2 between the data line 310 connected with the first sub-pixel 312a and/or with the third sub-pixel 312c and the pixel electrode 316. In other words, the coupling capacitance Cpd2 exists at least one of between the data line 310 connected with the first sub-pixel 312a and the pixel electrode 316, and the data line 310 connected with the third sub-pixel 312c and the pixel electrode 316.

In other words, the types of the active device substrate and the opposite substrate are not limited in the invention. Under possible circumstances, the active device substrate and the opposite substrate may be of the above types or may be combinations of other known types of substrates.

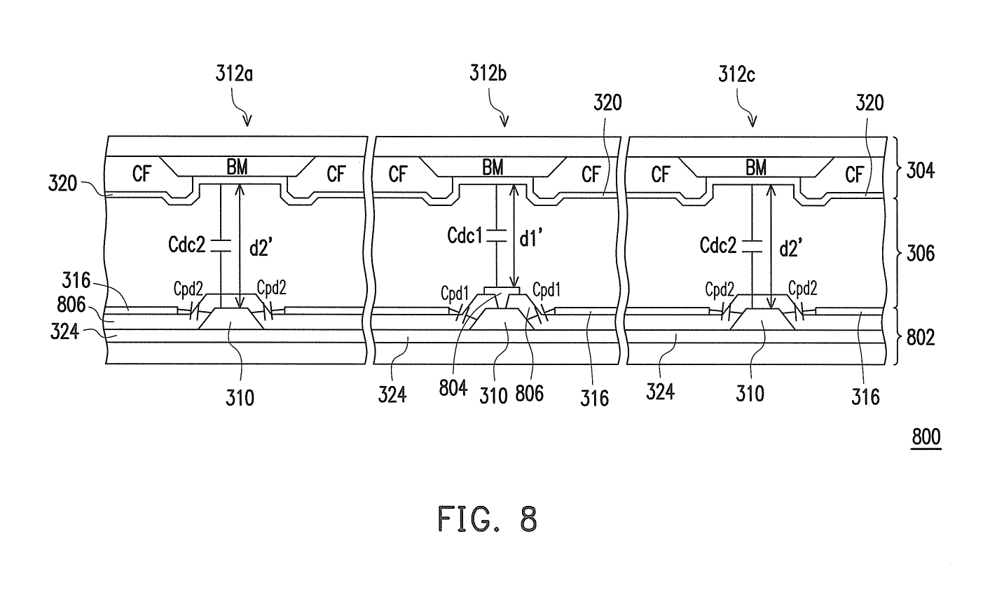

In addition to disposing the pad layer 322 beneath the part of the data line 310 connected with the second sub-pixel 312b, the LCD panel of the invention may be embodied in other configurations which are also capable of resolving the drifting of the common voltage CF_Vcom of the opposite substrate. The invention is hence not limited to the above arrangement. FIG. 8 is a partial schematic cross-sectional view of an active device substrate according to the fourth embodiment of the invention. It should be noted that in FIG. 8, the same elements as those in FIG. 4 are marked by the same reference numerals, and relevant descriptions are omitted.

Please refer to FIG. 8. According to the fourth embodiment, the elements which form an LCD panel 800 shown in FIG. 8 are substantially the same as the elements which form the LCD panel 300 shown in FIG. 4. The main difference in between lies in that a different arrangement is adopted to make the coupling capacitance Cdc1 between the data line connected with the second sub-pixel and the common electrode greater than the coupling capacitance Cdc2 between the data line connected with the first or the third sub-pixel and the common electrode.

In the LCD panel 800, an active device substrate 802 further includes a conductive pattern 804. The part of the data line 310 connected with the second sub-pixel 312b is, for example, located beneath the conductive pattern 804 and electrically connected with the conductive pattern 804. In detail, holes are formed in a passivation layer 806 (or called a dielectric layer) above the part of the data line 310 connected with the second sub-pixel 312b, so that the conductive pattern 804 is electrically connected with the part of the data line 310 beneath the passivation layer vis the holes. According to an embodiment, the material of the conductive pattern is substantially the same as the material of the pixel electrode 316, which is, for example, indium tin oxide (ITO), indium zinc oxide (IZO), zinc oxide (ZO), aluminum zinc oxide (AZO), cadmium zinc oxide (CZO), indium gallium zinc oxide (IGZO), another suitable material, or a combination of the above. In other words, the conductive pattern 804 and the pixel electrode 316 may be formed from the same layer of transparent conductive material, and are separated from each other by patterning, or are electrical insulated from each other. According to another embodiment, if the pixel electrode of the second sub-pixel is fowled from a reflective material (such as gold, silver, copper, aluminum, molybdenum, titanium, tantalum, tin, another suitable material, an alloy of the above, an oxide of the above, an oxynitride of the above, or a combination of the above), the material of the conductive pattern is a reflective material; alternatively, if the pixel electrode of the second sub-pixel is formed from a reflective material and a transparent conductive material, the material of the conductive pattern may be a reflective material, a transparent conductive material, or a combination of the above according to a design for the resistance requirement of the data line.

It should be noted that the a distance d1′ between the conductive pattern 804 disposed above the part of the data line 310 and the common electrode 320 is substantially less than a distance d2′ between each of the data lines 310 and the common electrode 320. In other words, the thickness of the liquid crystal layer 306 above the data line 310 that is connected with the second sub-pixel 312b is substantially less than the thickness of the liquid crystal layer 306 above the data line that is connected with the first sub-pixel 312a and/or with the third sub-pixel 312c. Since the voltage level of the conductive pattern 804 is the same as the voltage level of the data line 310 connected with the second sub-pixel 312b, by decreasing the distance d1′ between the conductive pattern 804 and the common electrode 314, the coupling capacitance Cdc1 between the data line 310 connected with the second sub-pixel 312b and the common electrode 314 is increased, so that the coupling capacitance Cdc1 is substantially greater than the coupling capacitance Cdc2 between the data line 310 connected with the first sub-pixel 312a and/or with the third sub-pixel 312c and the common electrode 314. In addition, the pattern and area of the conductive pattern 804 may be modified according to actual requirements, as long as the coupling capacitance Cdc1 between the data line 310 connected with the second sub-pixel 312b and the common electrode 314 of the opposite substrate is increased.

In addition, the coupling capacitance Cpd1 between the data line 310 connected with the second sub-pixel 312b and the pixel electrode 316 may also be affected by the disposition of the conductive pattern 804 on the part of the data line 310 connected with the second sub-pixel 312b. Hence, the disposition of the pixel electrode 316 may be further altered, so that the coupling capacitance Cpd1 between the data line 310 connected with the second sub-pixel 312b and the pixel electrode 316 is substantially equal to the coupling capacitance Cpd2 between the data line 310 connected with the first sub-pixel 312a and/or with the third sub-pixel 312c and the pixel electrode 316.

The invention does not limit the types of the active device substrate and the opposite substrate. In other words, the active device substrate in FIG. 8 may be altered to adopt the arrangement of elements in FIGS. 6 and 7 as described above.

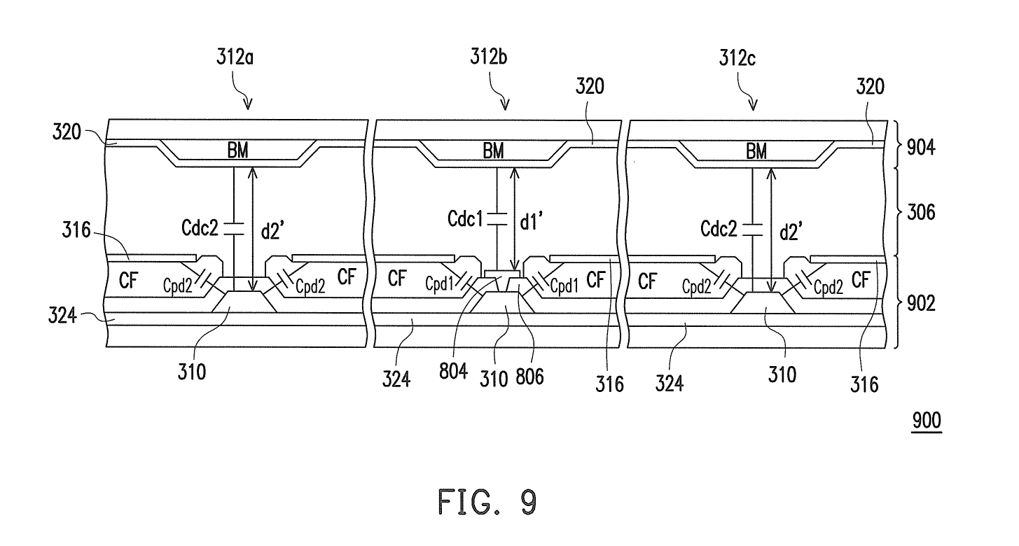

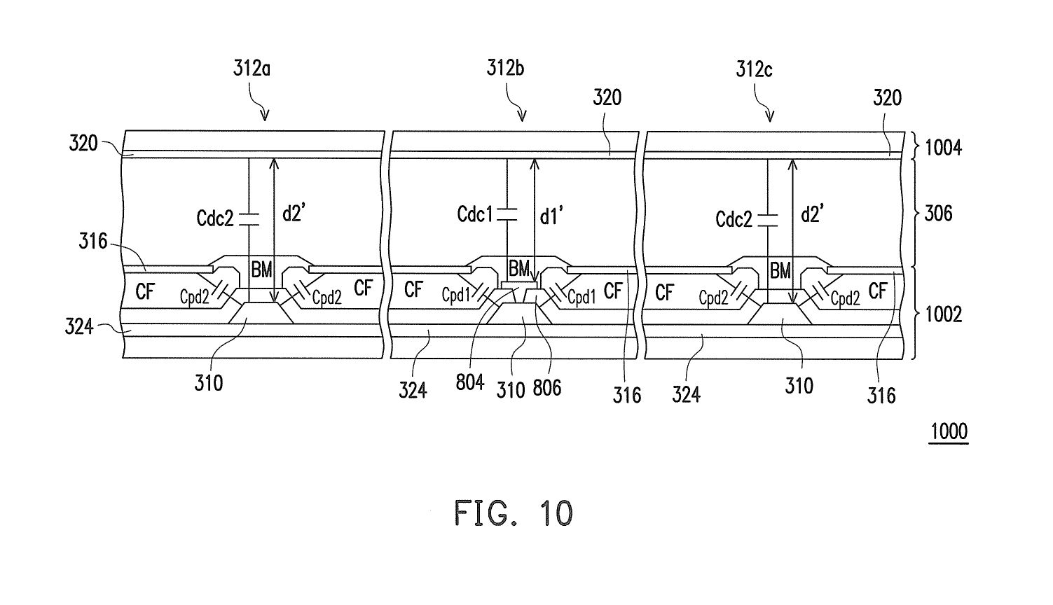

FIGS. 9 and 10 are partial schematic cross-sectional views of active device substrates according to the fifth and sixth embodiments of the invention, respectively. It should be noted that in FIGS. 9 and 10, the same elements as those in FIGS. 4 to 8 are marked by the same reference numerals, and relevant descriptions are omitted.

The elements which form LCD panels 900 and 1000 shown in FIGS. 9 and 10 are substantially the same as the elements which form the LCD panel 800 shown in FIG. 8. The main difference in between lies in the disposition of the elements of the active device substrate and the opposite substrate.

As shown in FIG. 9, in the LCD panel 900, an active device substrate 902 is, for example, similar to the COA substrate illustrated in FIG. 6. An opposite substrate 904 includes the common electrode 320 and the black matrixes BM, whereas the color filters CF are omitted. As shown in FIG. 10, in the LCD panel 1000, an active device substrate 1002 is, for example, similar to the BOA substrate illustrated in FIG. 7. An opposite substrate 1004 includes the common electrode 320, whereas the color filters CF and the black matrixes BM are omitted. In the LCD panel 1000, the conductive pattern 804 disposed above the part of the data line 310 is, for example, disposed beneath the black matrixes BM. One of ordinary skill in the art should readily know the applications and possible modifications according to the above embodiments, so that said applications and possible modifications are not described.

Similarly, according to the embodiments shown in FIGS. 9 and 10, the disposition of the pixel electrode 316 may be further altered, so that the coupling capacitance Cpd1 between the data line 310 connected with the second sub-pixel 312b and the pixel electrode 316 is substantially equal to the coupling capacitance Cpd2 between the data line 310 connected with the first sub-pixel 312a and/or with the third sub-pixel 312c and the pixel electrode 316.

Moreover, according to the above embodiments and figures, the invention is exemplarily described as including three sub-pixels. However, the invention is not limited to this arrangement. According to another embodiment, each of the pixels includes at least two sub-pixels, wherein the coupling effects between the first sub-pixel and the common electrode is greater than the coupling effects between the second sub-pixel and the common electrode. Hence, by adopting the arrangement described in the above embodiment, the coupling capacitance Cdc1 between the data line connected with the second sub-pixel with weaker coupling and the common electrode is substantially greater than the coupling capacitance Cdc2 between the data line connected with the first sub-pixel with stronger coupling and the common electrode, so that the problem of the shifting of the common voltage CF_Vcom is alleviated.

According to another embodiment, each of the pixels may include N sub-pixels, wherein N is an integer greater than 3. When each of the pixels includes N sub-pixels, the coupling capacitance Cdc between the data line connected with each sub-pixel and the common electrode in the opposite substrate may be similarly adjusted according to design requirements of the above embodiments, so that the voltage differences between the common voltage CF_Vcom and each of the sub-pixels are substantially equal. One of ordinary skill in the art should readily know the applications and possible modifications according to the above embodiments, so that said applications and possible modifications are not described.

Furthermore, according to the above embodiments, each of the pixels has two or three sub-pixels, and among the above sub-pixels, the data line of one of the sub-pixels has the design of the invention. However, the invention is not limited to the above arrangement. According to another embodiment, the data lines of two of the three sub-pixels in the above embodiments have the design of the invention. If each of the pixels includes four, five, or six sub-pixels, the coupling effects between the one of the sub-pixels and the common electrode should be greater than the coupling effects between the other sub-pixels and the common electrode. Hence, by adopting the arrangement described in the above embodiment, the coupling capacitance Cdc1 between the data line connected with the sub-pixel with weaker coupling and the common electrode is substantially greater than the coupling capacitance Cdc2 between the data line connected with the sub-pixel with stronger coupling and the common electrode, so that the problem of shifting of the common voltage CF_Vcom is alleviated.

In summary, in the LCD panel of the invention, the coupling capacitance Cdc1 between the data lines connected with some of the sub-pixels and the common electrode is greater than the coupling capacitance Cdc2 between the data lines connected with any of the other sub-pixels and the common electrode. Therefore, when the LCD panel uses dot inversion or column inversion to drive the sub-pixel array to display the testing pattern of alternating black and white, by increasing the coupling capacitance Cdc1 between the data line connected with the second sub-pixel and the common electrode to alleviate the phenomenon of shifting of the common voltage C_Vcom of the opposite substrate, the phenomenon of color shifting and incorrect white balance are alleviated. The LCD panel of the invention is hence able to avoid problems of conventional non-uniform displaying.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A liquid crystal display (LCD) panel, comprising:
an active device substrate, comprising:
a plurality of scan lines;
a plurality of data lines, intersected with the scan lines;
a plurality of pixels, each of the pixels at least comprising a first sub-pixel, a second sub-pixel, and a third sub-pixel, wherein the first sub-pixel, the second sub-pixel, and the third sub-pixel of each of the pixels are electrically connected with different data lines respectively and connected with the same scan line;
an opposite substrate, disposed above the active device substrate and having a common electrode, wherein coupling capacitance (Cdc1) between the data line connected with each of the second sub-pixels and the common electrode is substantially greater than coupling capacitance (Cdc2) between the data line connected with each of the first sub-pixels and/or with the third sub-pixels and the common electrode; and
a liquid crystal layer, disposed between the active device substrate and the opposite substrate.

2. The LCD panel of claim 1, wherein the first sub-pixels are red sub-pixels, the second sub-pixels are green sub-pixels, and the third sub-pixels are blue sub-pixels.

3. The LCD panel of claim 1, wherein the active device substrate further comprises an additional layer, the additional layer is disposed beneath a part of each of the data lines connected with the second sub-pixels, and a distance (d1) between the parts of the data lines connected with the second sub-pixels and the common electrode is substantially less than a distance (d2) between the parts of the data lines connected with the first sub-pixels and/or with the third sub-pixels and the common electrode.

4. The LCD panel of claim 3, wherein a material of the additional layer is substantially the same as a material of the scan lines.

5. The LCD panel of claim 3, wherein a material of the additional layer comprises silicon nitride or polysilicon.

6. The LCD panel of claim 1, wherein the active device substrate further comprises a conductive pattern, wherein the parts of the data lines connected with the second sub-pixels are electrically connected with the conductive pattern and are disposed beneath the conductive pattern, a distance (d1′) between the conductive pattern and the common electrode is substantially less than a distance (d2′) between each of the data lines and the common electrode.

7. A liquid crystal display (LCD) panel, comprising:
an active device substrate, comprising:
a plurality of scan lines;
a plurality of data lines, intersected with the scan lines;
a plurality of pixels, each of the pixels at least comprising a first sub-pixel, a second sub-pixel, and a third sub-pixel, a polarity of the first sub-pixel being opposite to a polarity of the second sub-pixel, and the polarity of the first sub-pixel being the same as a polarity of the third sub-pixel, wherein the first sub-pixel, the second sub-pixel, and the third sub-pixel of each of the pixels are electrically connected with different data lines respectively and connected with the same scan line;
an opposite substrate, disposed above the active device substrate and having a common electrode, wherein coupling capacitance (Cdc1) between each of the data lines connected with the second sub-pixels and the common electrode is substantially greater than coupling capacitance (Cdc2) between each of the data lines connected with the first sub-pixels and/or with the third sub-pixels and the common electrode; and
a liquid crystal layer, disposed between the active device substrate and the opposite substrate.

8. The LCD panel of claim 7, wherein the first sub-pixels are red sub-pixels, the second sub-pixels are green sub-pixels, and the third sub-pixels are blue sub-pixels.

9. The LCD panel of claim 7, wherein the active device substrate further comprises an additional layer, the additional layer is disposed beneath a part of each of the data lines connected with the second sub-pixels, and a distance (d1) between the parts of the data lines connected with the second sub-pixels and the common electrode is substantially less than a distance (d2) between the parts of the data lines connected with the first sub-pixels and/or with the third sub-pixels and the common electrode.

10. The LCD panel of claim 9, wherein a material of the additional layer is substantially the same as a material of the scan lines.

11. The LCD panel of claim 9, wherein a material of the additional layer comprises silicon nitride or polysilicon.

12. The LCD panel of claim 9, wherein the active device substrate further comprises a conductive pattern, wherein the parts of the data lines connected with the second sub-pixels are electrically connected with the conductive pattern and are disposed beneath the conductive pattern, and a distance (d1′) between the conductive pattern and the common electrode is substantially less than a distance (d2′) between each of the data lines and the common electrode.

13. A liquid crystal display (LCD) panel, comprising:
an active device substrate, comprising:
a plurality of scan lines;
a plurality of data lines, intersected with the scan lines;
a plurality of pixels, each of the pixels at least comprising a first sub-pixel and a second sub-pixel, wherein the first sub-pixel and the second sub-pixel of each of the pixels are electrically connected with different data lines respectively and connected with the same scan line;
an opposite substrate, disposed above the active device substrate and having a common electrode, coupling effects between the first sub-pixel and the common electrode being greater than coupling effects between the second sub-pixel and the common electrode, wherein coupling capacitance (Cdc1) between each of the data lines connected with the second sub-pixels and the common electrode is substantially greater than coupling capacitance (Cdc2) between each of the data lines connected with the first sub-pixels and the common electrode; and
a liquid crystal layer, disposed between the active device substrate and the opposite substrate.

14. The LCD panel of claim 13, wherein the active device substrate further comprises an additional layer, the additional layer is disposed beneath a part of each of the data lines connected with the second sub-pixels, and a distance (d1) between the parts of the data lines connected with the second sub-pixels and the common electrode is substantially less than a distance (d2) between the data lines connected with the first sub-pixels and the common electrode.

15. The LCD panel of claim 13, wherein a material of the additional layer is substantially the same as a material of the scan lines.

16. The LCD panel of claim 13, wherein a material of the additional layer comprises silicon nitride or polysilicon.

17. The LCD panel of claim 13, wherein the active device substrate further comprises a conductive pattern, wherein the parts of the data lines connected with the second sub-pixels are electrically connected with the conductive pattern and are disposed beneath the conductive pattern, and a distance (d1′) between the conductive pattern and the common electrode is substantially less than a distance (d2′) between each of the data lines and the common electrode.
